(19) United States
(12) Patent Application Publication
(10) Pub. No.: US 2010/0221448 A1
(43) Pub. Date: Sep. 2, 2010

(54) METHOD FOR DEPOSITING A WEAR COATING ON A HIGH STRENGTH SUBSTRATE WITH AN ENERGY BEAM

(75) Inventors: Don Mittendorf, Mesa, AZ (US); Amer Aizaz, Phoenix, AZ (US); Robbie Joseph Adams, Phoenix, AZ (US); Martin Carlin Baker, Budd Lake, NJ (US); Christopher Lee Cahoon, Mesa, AZ (US); Tom Murray, Phoenix, AZ (US); Calum Macintyre, Phoenix, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/394,791

(22) Filed: Feb. 27, 2009

(51) Int. Cl. B05D 3/00; B05D 1/36

(52) U.S. Cl. 427/532; 427/404

(57) ABSTRACT

A method of forming a wear-resistant coating on a surface of a substrate includes the step of depositing a material comprising a rhenium-based composition onto the substrate surface using a handheld laser deposition device. A soluble interlayer may be formed on the surface of the substrate prior to the laser deposition step, and a heat treatment may be performed after the laser deposition step.

### TECHNICAL FIELD

The present invention relates to methods for applying refractory metal alloy wear coatings onto articles such as aerospace components and, more particularly, to methods for depositing the wear coating using a concentrated energy beam.

### BACKGROUND

The aerospace industry is continuously seeking to increase the operating temperatures for launch vehicle components and equipment and/or for aircraft engines and auxiliary equipment, and to thereby enhance the performance and increase the operational life for such products. Since component wear and degradation is problematic, particularly at high temperatures, one approach toward improving heat resistance for aerospace components is to add wear-resistant coatings to their surfaces. However, there is a trade off between increased operational life and the expense associated with applying the wear-resistant coatings. Iron and nickel-based alloys are just some conventional base materials that benefit from wear-resistant coatings, but adding such coatings may substantially increase the cost of manufacturing the components.

One class of materials that has excellent wear rates includes refractory metals such as rhenium and rhenium alloys. Many refractory metals and their alloys are wear-resistant, making them suitable candidates for thin wear-resistant coatings rather than as base coatings. However, refractory materials are typically not only expensive, but may rely on costly processes to apply.

Further, even though such materials have the requisite high temperature strength and/or wear properties to form suitable wear-resistant coatings, their melting temperatures are so much higher than that of the substrates being coated that the refractory metals can be difficult to apply using conventional application methods. Thermal spraying treatments such as high velocity oxygen fuel (HVOF) spraying and thermal plasma spraying frequently involve raising the spraying material to its melting temperature to enable bonding and diffusion between the substrate and the spraying material. However, a large differential between the melting temperatures for the substrate and the spraying material may cause thermal spraying processes to be impractical because the melted spraying material may deform or otherwise damage the substrate. For example, rhenium melts at 3172° C., and typical powder metallurgy consolidation, including pure rhenium, occurs at temperatures of at least 1800° C. and from about 1360 to about 2040 atm. Since many steel alloys melt near or below 1480° C., and many nickel alloys melt near or below 1370° C., conventional thermal spraying and other powder metallurgy techniques may not be suitable for forming and consolidating coatings of rhenium or similar refractory metals and alloys on steel or nickel-based alloys. Another reason that conventional thermal spraying may not be suitable is because refractory metals are known to oxidize under these processing conditions altering both the chemical and physical characteristics of the coating.

As previously stated, one approach toward improving heat resistance for aerospace components, including those subject to high contact stresses is to add wear-resistant coatings to their surfaces through high heat spraying techniques. Often high strength steel is chosen as the component substrate material due to its high strength. High strength steels, when heated to a high temperature, change solid state phase resulting in drastic dimensional changes. These changes make coating with refractory materials difficult.

Hence, there is a need for a method that efficiently and cost-effectively produces a wear-resistant coating from high temperature refractory alloy materials that have high strength or hardness. More particularly, a need exists for a coating method by which such materials can be uniformly and thoroughly applied onto a substrate. There is also a need for producing such coatings that are sufficiently thin to be effective yet lightweight.

### BRIEF SUMMARY

The present invention provides a method of forming a wear-resistant coating on a substrate surface. In one particular embodiment, and by way of example only, there is provided a method including the steps of forming a wear-resistant coating on a surface of a substrate, comprising: applying a soluble interlayer onto the surface of the substrate; and depositing a feedstock material comprising a rhenium-based composition onto the soluble interlayer. The soluble interlayer comprises a metal that is soluble with both the surface of the substrate and the feedstock material, the soluble interlayer further comprising one or more elements selected from the group consisting of nickel, chromium, cobalt, vanadium, scandium, rhodium, palladium, tantalum, platinum, osmium, columbium, molybdenum, manganese, iridium, hafnium, iron, chromium, zirconium, titanium, silicon, boron, and beryllium.

In another embodiment, and by way of example only, there is provided a method of forming a wear-resistant coating on a surface of a substrate, comprising: forming a soluble interlayer on the surface of the substrate; depositing a wear-resistant coating layer with an energy beam based deposition system onto the soluble interlayer, the wear-resistant coating layer comprising a rhenium-based alloy and an additional material selected from the group consisting of alumina, aluminum oxide, alumina titanate, aluminum nitride, beryllium oxide, boron nitride, silicon nitride, cobalt oxide, diamond, entatite, fosterite, tungsten carbide, nickel oxide, niobium carbide, rhenium diboride, silica, zirconia, silicon carbide, tantalum carbide, tantalum niobium carbide, titanium carbide, titanium nitride, titanium carbonitride, titanium diboride, tungsten, tungsten disulfide, tungsten sulfide, and tungsten titanium carbide; and heat treating the wear-resistant coating layer.

In yet another exemplary embodiment, and by way of example only, there is provided a method of forming a wear-resistant coating on a surface of a substrate, comprising: forming a soluble interlayer on the surface of the iron based substrate, the soluble interlayer characterized as soluble with the surface of the iron based substrate; depositing a wear-resistant coating layer with an energy beam based deposition system onto the soluble interlayer, the wear-resistant coating layer comprising a rhenium-based alloy that includes at least about 50% rhenium by atomic percent; and heat treating the wear-resistant coating layer.

Other independent features and advantages of the preferred methods will become apparent from the following detailed description, taken in conjunction with the accompanying drawing which illustrates, by way of example, the principles of the invention.

### BRIEF DESCRIPTION OF THE DRAWING

The present invention will hereinafter be described in conjunction with the following drawing figure, wherein:

FIG. 1 is a schematic view of a hand held laser apparatus according to an embodiment;

FIG. 2 is a schematic view of a hand held laser apparatus according to another embodiment;

FIG. 3 is a flow chart depicting an exemplary method for forming a wear-resistant coating on a substrate; and

FIG. 4 is a cross-sectional view of a workpiece having a wear-resistant coating formed thereon using a hand held laser deposition process.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention. create high-precision repairs that are cost effective, even for those components with complex part geometries

Energy beam coating systems, such as laser systems and other electromagnetic heat source systems, commonly utilize an energy source of sufficient intensity to melt a substrate surface while a feedstock material in the form of a powder, wire or rod is introduced into the melt pool and more specifically, at a junction of the energy beam with the substrate. In situations where the substrate surface is not accessible by conventional workstation type of equipment, a compact hand-held torch is preferred. Other cases may involve the coating of parts having irregular surfaces not otherwise accessible by robotic or, programmable workstations. In order to form a wear-resistant coating on a substrate of this type, a portable, flexible delivery system is required for both the energy beam delivery means as well as the feedstock material. This invention provides for these needs through the integration of an energy beam based system, such as a laser beam, in the form of a hand held system and a feedstock material delivery component, that may be integrated into a single compact hand-held unit or separately formed components. Alternatively, this invention provides for deposition of feedstock materials through the integration of a gas based deposition system, such as a tungsten inert gas (TIG) welding system or spray based system, such as by plasma spray delivery. With regard to energy beam, and more specifically laser beam based deposition systems, currently, a preferred laser source is a continuous wave Nd:YAG laser, of medium to high power (e.g., 600-1000 watts), capable of melting a variety of metals when focused to a spot at the substrate surface. In a YAG (Nd:YAG) laser, the amplifying medium is a rod of yttrium aluminum garnet (YAG) containing ions of the lanthanide metal neodymium (Nd). Other laser and/or feedstock feed sources may be used, as required for particular applications.

In the case of a hand held laser deposition system, the feedstock may be fed to the laser substrate junction through tubes that surround the laser beam. For example, U.S. Pat. No. 6,593,540, entitled “Hand Held Powder-Fed Laser Fusion Welding Torch” describes one exemplary apparatus designed to provide manual flexibility for welding with a powder fed feedstock material. Additional exemplary embodiments of hand-held laser welding wands are disclosed in U.S. Pat. No. 7,030,337, which is entitled “Hand-Held Laser Welding Wand Having Removable Filler Media Delivery Extension Tips” and U.S. Pat. No. 7,012,216, which is entitled “Hand-Held Laser Welding Wand Having Internal Coolant and Gas Delivery Conduits,” the entirety of which are hereby incorporated by reference. One of the significant features of a hand held laser device is that the controlling optics may be encased in a wand small enough to be held by the hand. Thus, it can be used as a more conventional welding torch or attached to a holder and mechanized or automated. However, hand held operation dramatically increases the flexibility of application that conventional energy beams and particularly mechanized lasers do not have. Thus, a small amount of the wear-resistant coating and especially refractory coating can be applied to a small area for original equipment manufacture, repair or hybrid construction.

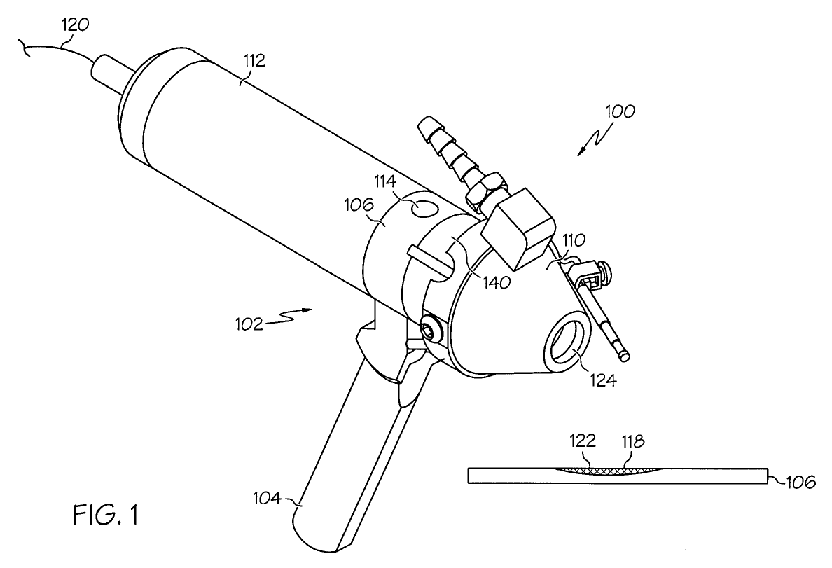

Turning now to FIG. 1, an exemplary hand held laser device 100 is illustrated. The laser device 100 is illustrated as a general scheme, and additional features and components can be implemented into the device 100 as necessary. The main components of the hand held laser device 100 include a torch assembly 102, generally comprised of a handle 104, to which a body 106 is attached. The body 106 provides an interchangeable element to which a nozzle 110 and a beam delivery assembly 112, as well as the handle 104, may be attached in an interchangeable and convenient fashion.

An upper aperture 114 serves as an inlet through which bleed gas may flow into the torch assembly 102. The bleed gas provides a generally inert environment through which the laser light may travel, and prevents oxidation or other chemical reactions by the laser light. Additionally, the inert gas may provide an optically predictable environment through which the laser light may travel. The torch assembly 102 is generally comprised of an optical system to focus the laser beam onto a workpiece 116, and a feedstock delivery means to deposit a metal alloy feedstock material into a metal melt pool 118 produced by the focused laser radiation. The feedstock material in this particular embodiment is described as being in the form of a powder, but it should be understood that feedstock material in alternate forms, such as a wire, rod, or the like, are anticipated.

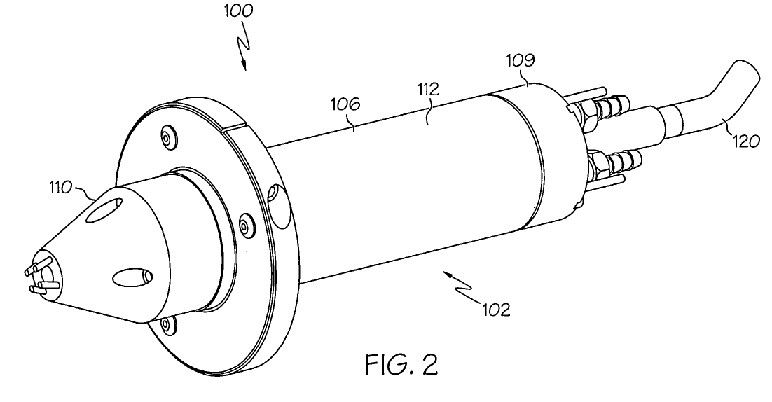

As best illustrated in FIG. 2, an alternate embodiment of a hand held laser device 100 is illustrated. It should be noted that all components of FIG. 2 that are similar to the components illustrated in FIG. 1, are designated with similar numbers. In this particular embodiment, the hand held laser device 100 generally comprises a torch assembly 102, including a main body 106, a nozzle 110, a beam delivery assembly 112 housed therein, and an end cap 109. The main body 106, which is preferably configured as a hollow tube, includes a first end and a second end. The main body 106 additionally includes a plurality of orifices and flow passages. These orifices and flow passages are used to direct various fluids and other media through the main body 106 and to the nozzle 110 Included among these media are coolant, such as water, inert gas, such as Argon, and filler materials, such as powder, wire, or liquid. The main body 106 further includes one or more filler media flow passages (not shown) that may be used to supply feedstock to a work piece. The nozzle 1104, as was noted above, is coupled to the main body 106 and includes an aperture (not shown) that extends through the nozzle 110 and fluidly communicates with the inside of the hollow main body 106. It is through this aperture that laser light passes during laser welding operations.

Referring again to FIG. 1, the torch assembly 102 is optically coupled to a laser source (not shown) through a flexible fiber optic light cable 120. Laser energy emitted by the source is transmitted through the fiber optic light cable 120 to collimating and focusing optics contained within the beam delivery assembly 112 and the body 106. A focal spot size is selected to produce the desired melting of the substrate material at the lowest possible laser output power. Melt pool diameter, depth of penetration, heat affected zone (HAZ) dimensions and weld rate are closely related to the laser focal spot diameter and total laser output power.

In one specific embodiment, a feedstock material comprised of a metal powder, such as a rhenium powder, is introduced into a weld zone 122 through a plurality of nozzles or tubes (not shown), contained within or attached to the torch assembly 102. In one embodiment, a feedstock material outlet is coaxial with the optical beam path exiting at an aperture 124. In another specific embodiment, an offset nozzle design may be utilized and may include a separate, hand-held off-axis feedstock delivery nozzle or nozzles, not attached to the torch assembly 102. It should be understood that greater flexibility in manipulating the torch assembly 102 may be provided by the coaxial design.

The effect of the energy or more specifically the laser and especially the hand held laser will usually melt the substrate at the laser-substrate junction, or weld-zone 122. In many instances, the laser beam will substantially melt the feedstock material. However, in some cases the feedstock material, especially if it is powder, will not melt completely but will be entrained into the molten substrate at the laser-substrate surface junction 122. Energy beam deposition techniques, and in particular hand held laser deposition systems, can therefore produce a wear or corrosion-resistant coating that strengthens and protects the component using feedstock materials that may not be able to be applied using techniques that utilize work station equipment systems. It should be understood that although a specific laser system geometry is described herein, alternate geometries can be utilized provided they permit line of sight application of the laser beam and the feedstock material.

According to an exemplary hand held laser deposition coating method, one or more refractory materials that have high melting temperatures are deposited using the hand held laser device, similar to those previously described in FIG. 1 or 2, onto a substrate to form a wear-resistant coating. Rhenium and/or rhenium alloys are preferred refractory materials for forming such coatings due in part to the exceptional wear rates for coatings formed from such materials. The combination of the wear-resistant coating with a substrate, such as an iron based material, with a thin but highly wear-resistant coating results in a relatively inexpensive component having an extended operational life. Other substrates that may advantageously be coated with the wear-resistant coating include iron or nickel-based substrates, cobalt, molybdenum, tungsten, chromium, titanium, aluminum, and magnesium-based alloys.

Some exemplary rhenium alloys and rhenium-based materials include elements and/or compounds that have substantially lower melting temperatures than rhenium, but have full or partial solubilities with rhenium. Cobalt, nickel, chromium, boron, and manganese are some elements that have low melting temperatures and partial to high solubility with rhenium. Additional refractory materials such as silicon carbide may also be included in the alloy, either as reacted alloy components, separate components, or as particles coated by the rhenium-based alloy. These elements and materials enhance consolidation of rhenium particles, most likely by enhancing the deformability of the alloy as a whole upon impact with a substrate during the laser deposition process. Further, these and other low melting temperature elements enhance diffusion at the substrate/particle interface during any post-deposition processes such as annealing or sintering.

In addition to silicon carbide, other ceramics, glass, metals and related materials may be mixed with the rhenium-based alloy feedstock material. Some exemplary additional materials include alumina, aluminum oxide, alumina titanate, aluminum nitride, beryllium oxide, boron nitride, silicon nitride, cobalt oxide, diamond, entatite, fosterite, tungsten carbide, nickel oxide, niobium carbide, rhenium diboride, silica, zirconia, silicon carbide, tantalum carbide, tantalum niobium carbide, titanium carbide, titanium nitride, titanium carbonitride, titanium diboride, tungsten, tungsten disulfide, tungsten sulfide, and tungsten titanium carbide.

Rhenium alloys that may be deposited using a hand held laser device to form a wear-resistant coating include rhenium as the most abundant element in terms of atomic percent percent, and preferably include at least about 50% rhenium. An example of such an alloy includes, in terms of atomic percent, about 50% rhenium, 20% cobalt, 15% chromium, 10% nickel, and 5% manganese. Also, ceramic particles that are encapsulated in a rhenium alloy may be laser deposited to form a wear-resistant coating. An exemplary coated material includes, in terms of atomic percent, silicon carbide particles at about 15% of the total material. The silicon carbide particles are encapsulated in an alloy that includes, in terms of the total material atomic percent, about 50% rhenium, 10% cobalt, 10% nickel, 10% chromium, and 5% manganese. As previously discussed, these are just a couple of examples of materials and alloys that may be deposited on an iron based substrate, or various other relatively high strength substrates, to form a wear-resistant coating.

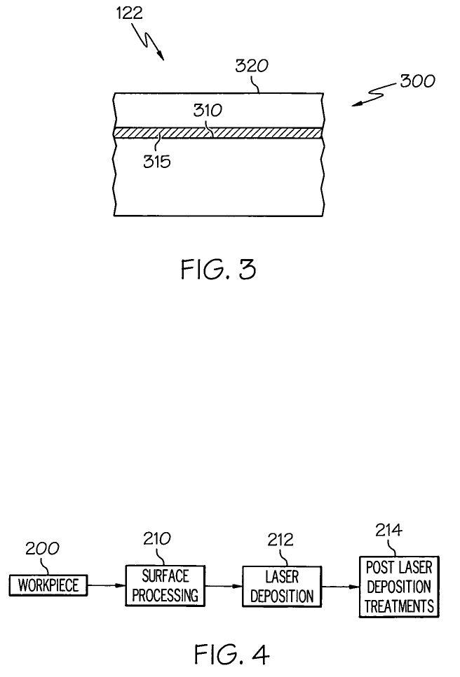

Turning now to FIG. 3, an exemplary method for forming a wear-resistant coating is outlined in a flow diagram. First, a workpiece is selected as step 200 based on a need for a wear-resistant coating on a workpiece surface. FIG. 4 is a cross-sectional view of a workpiece 300 having a surface 310 coated with a wear-resistant coating 320. An exemplary workpiece 300 is an aerospace engine component such as a face seal, although there are numerous workpieces in various technologies that would benefit from a wear-resistant coating applied using the method outlined in FIG. 3. Iron-based alloys including steel, and preferably high strength steel or steel alloys, are ideal substrates for receiving a wear-resistant coating, as are substrates formed from nickel-based alloys and superalloys.

After selecting a suitable workpiece, the targeted workpiece surface 310 is prepared for receiving a wear-resistant coating as step 210 in the method. For example, preparing a workpiece surface may involve surface rebuilding steps, pre-machining, degreasing, and grit blasting the targeted workpiece surface 310 in order to remove any oxidation or contamination. Surface processing may further include forming a soluble interlayer 315 on the targeted workpiece surface 310. The soluble interlayer 315 may be applied by a conventional technique such as electroplating, spraying, or by laser deposition, and is formed from using a material that is soluble with both the material forming the workpiece surface and the material that will form the wear-resistant coating 320. For example, if a rhenium-based wear-resistant coating is to be formed on a steel substrate, one exemplary soluble interlayer would be formed from nickel, since nickel is soluble with both rhenium and steel. Depending on the wear-resistant coating and workpiece materials, other suitable materials for forming the soluble interlayer may include one or more different elements such as nickel, chromium, cobalt, vanadium, scandium, rhodium, palladium, tantalum, platinum, osmium, columbium, molybdenum, manganese, iridium, hafnium, iron, chromium, zirconium, titanium, silicon, boron, and beryllium.

Upon preparing the workpiece surface, the wear-resistant coating 320 is formed by laser deposition of a refractory material as step 212 onto the targeted workpiece surface 310 and/or the soluble interlayer 315, if present, using a hand held laser, such as the ones depicted in FIG. 1 or 2. As previously discussed, during a laser deposition process feedstock particles at a temperature below their melting temperature are accelerated and directed to the targeted workpiece surface 310. When the feedstock particles corn in contact the targeted workpiece surface 310, the feedstock particles may reside on the targeted workpiece surface 310 and/or may be entrained into the molten substrate surface at the substrate-laser junction. Any of the previous-discussed refractory materials or mechanical mixtures may be used, although rhenium-based alloys are preferred. The laser deposition step 212 forms the wear-resistant coating 320 and generally maintains the component's desired dimensions, although additional machining can be performed if necessary to accomplish dimensional restoration.

After the laser deposition step, thermal treatments may be performed as step 214 as necessary or desirable to cause the separate metal elements within the wear-resistant coating 320, and at the interface between the wear-resistant coating 320 and the targeted workpiece surface 310 and/or the soluble interlayer 315, to diffuse as desirable. An exemplary thermal treatment includes one or more processes such as a heat treatment, a hot isostatic pressing treatment, or a sintering treatment such as vacuum sintering, to form the desired alloy with a substantially uniform microstructure and composition.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method of forming a wear-resistant coating on a surface of a substrate, comprising:
applying a soluble interlayer onto the surface of the substrate; and
depositing a feedstock material comprising a rhenium-based composition onto the soluble interlayer,
wherein the soluble interlayer comprises a metal that is soluble with both the surface of the substrate and the feedstock material, the soluble interlayer further comprising one or more elements selected from the group consisting of nickel, chromium, cobalt, vanadium, scandium, rhodium, palladium, tantalum, platinum, osmium, columbium, molybdenum, manganese, iridium, hafnium, iron, chromium, zirconium, titanium, silicon, boron, and beryllium.

2. The method according to claim 1, wherein the substrate is formed of an iron based material.

3. The method according to claim 1, wherein the substrate is formed from an alloy selected from the group consisting of cobalt, molybdenum, tungsten, chromium, magnesium, iron, titanium, aluminum, and nickel-based alloys.

4. The method according to claim 1, wherein the rhenium-based composition is a rhenium-based alloy.

5. The method according to claim 4, wherein the rhenium-based composition comprises a rhenium-based alloy that includes at least about 50% rhenium by atomic percent.

6. The method according to claim 5, wherein the rhenium-based composition comprises a rhenium-based alloy that comprises at least one element selected from the group consisting of cobalt, chromium, nickel, and manganese.

7. The method according to claim 6, wherein the rhenium-based composition comprises a rhenium-based alloy that comprises cobalt, chromium, nickel, and manganese.

8. The method according to claim 7, wherein the rhenium-based composition comprises a rhenium-based alloy that comprises by atomic percent about 20% cobalt, about 15% chromium, about 10% nickel, and about 5% manganese.

9. The method according to claim 1, wherein the step of depositing a feedstock material comprising a rhenium-based composition onto the soluble interlayer comprises depositing using at least one of energy beam based deposition system, a gas based deposition system, or a spray based deposition system.

10. The method according to claim 1, wherein the feedstock material comprises by atomic percent about 15% silicon carbide as the refractory material encapsulated in or mixed with the rhenium-based composition, and further comprises about 10% cobalt, about 10% chromium, about 10% nickel, and about 5% manganese, the rhenium, cobalt, chromium, nickel, and manganese being elements in the rhenium-based composition.

11. A method of forming a wear-resistant coating on a surface of a substrate, comprising:
forming a soluble interlayer on the surface of the substrate;
depositing a wear-resistant coating layer with an energy beam based deposition system onto the soluble interlayer, the wear-resistant coating layer comprising a rhenium-based alloy and an additional material selected from the group consisting of alumina, aluminum oxide, alumina titanate, aluminum nitride, beryllium oxide, boron nitride, silicon nitride, cobalt oxide, diamond, entatite, fosterite, tungsten carbide, nickel oxide, niobium carbide, rhenium diboride, silica, zirconia, silicon carbide, tantalum carbide, tantalum niobium carbide, titanium carbide, titanium nitride, titanium carbonitride, titanium diboride, tungsten, tungsten disulfide, tungsten sulfide, and tungsten titanium carbide; and
heat treating the wear-resistant coating layer.

12. The method according to claim 11, wherein the substrate is formed of iron based material.

13. The method according to claim 11, wherein the substrate is formed from an alloy selected from the group consisting of cobalt, molybdenum, tungsten, chromium, magnesium, iron, titanium, aluminum, and nickel-based alloys.

14. The method according to claim 11, wherein the rhenium-based alloy includes at least about 50% rhenium by atomic percent.

15. The method according to claim 14, wherein the rhenium-based alloy comprises at least one element selected from the group consisting of cobalt, chromium, nickel, and manganese.

16. The method according to claim 15, wherein the rhenium-based alloy comprises cobalt, chromium, nickel, and manganese.

17. The method according to claim 11, wherein the additional material comprises a refractory material encapsulated in or mixed with the rhenium-based alloy.

18. The method according to claim 11, wherein the step of forming the soluble interlayer comprises forming the soluble interlayer from a metal that is soluble with both the surface of the substrate and the wear-resistant coating layer, the soluble interlayer further comprising one or more elements selected from the group consisting of nickel, chromium, cobalt, vanadium, scandium, rhodium, palladium, tantalum, platinum, osmium, columbium, molybdenum, manganese, iridium, hafnium, iron, chromium, zirconium, titanium, silicon, boron, and beryllium.

19. A method of forming a wear-resistant coating on a surface of an iron based substrate, comprising:
forming a soluble interlayer on the surface of the iron based substrate, the soluble interlayer characterized as soluble with the surface of the iron based substrate;
depositing a wear-resistant coating layer with an energy beam based deposition system onto the soluble interlayer, the wear-resistant coating layer comprising a rhenium-based alloy that includes at least about 50% rhenium by atomic percent; and
heat treating the wear-resistant coating layer.

20. The method according to claim 19, wherein the rhenium-based alloy comprises at least one element selected from the group consisting of cobalt, chromium, nickel, and manganese.
